(19) United States
(12) Patent Application Publication
(10) Pub. No.: US 2010/0314990 A1
(43) Pub. Date: Dec. 16, 2010

(54) HOUSING AND ELECTRONIC DEVICE THEREOF

(75) Inventors: BEN-DING TSAO, Shindian (TW); WEN-LIN XIONG, Shenzhen City (CN); DONG-SHENG WENG, Shenzhen City (CN); HONG-XI XU, Shenzhen City (CN); QI-QUAN YAN, Shenzhen City (CN); DIAN-MING ZHU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/618,077

(22) Filed: Nov. 13, 2009

(30) Foreign Application Priority Data
Jun. 11, 2009 (CN) 200910303178.2

(51) Int. Cl. H01J 1/62

(52) U.S. Cl. 313/498

(57) ABSTRACT

A housing comprises an exterior coating and a substrate. The housing further comprises a first conductive coating, a light emitting coating and a second conductive coating formed between the exterior coating and the substrate. The substrate formed on the second conductive coating by molding. The first and the second conductive coatings include electric contacts. An electronic device using the housing is also described there.

### BACKGROUND

1. Technical Field

The present disclosure relates to housings, especially to a luminescent housing and an electronic device thereof.

2. Description of Related Art

With developments in electronic products, consumers have being paying more attention to the external appearance of electronic products. Electronic products having luminescent housings are highly desirable. Methods for fabricating luminescent housing include using fluorescent ink, light-emitting diode (LED) lamps, and electroluminescent cells. However, fluorescent inks require a light source and have a short lifespan. LED lamps are bulky, expensive, and use more power. Electroluminescent cells are difficult to fix in place and are also bulky.

Therefore, there is room for improvement within the art.

### BRIEF DESCRIPTION OF THE FIGURES

Many aspects of the housing and electronic device thereof can be better understood with reference to the following figures. The components in the figures are not necessarily drawn to scale, the emphasis instead being placed upon clearly illustrating the principles of the housing. Moreover, in the drawings like reference numerals designate corresponding parts throughout the several views.

FIG. 1 is a cross-sectional view of an exemplary embodiment of a housing.

FIG. 2 is a schematic view of an exemplary embodiment of an electronic device using the housing shown in FIG. 1.

### DETAILED DESCRIPTION

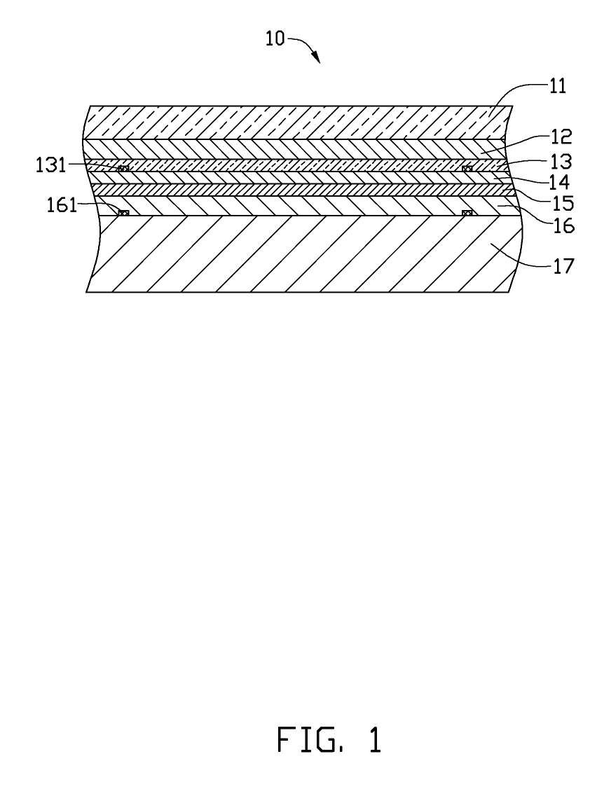

Referring to FIG. 1, in an exemplary embodiment, a housing 10 includes an exterior coating 11 and a substrate 17. The housing 10 further includes a decorative coating 12, a first conductive coating 13, a light emitting coating 14, an insulating coating 15, and a second conductive coating 16, all of which are formed between the exterior coating 11 and the substrate 17. The coatings 11-16 are applied sequentially to the interior of a mold and then transferred to the substrate 17 in a molding process to form the housing 10.

The exterior coating 11 is a transparent plastic coating. The thickness of the exterior coating 11 can be about 0.1-0.2 mm. The exterior coating 11 can undergo surface treatment to smoothen its surface smoother after the housing 10 is molded.

The decorative coating 12 can be a colorful ink coating. The ink used for forming the decorative coating 12 can be transparent or translucent. The decorative coating 12 can form aesthetic patterns or display information such as a company logo, etc. The decorative coating 12 can be formed on a portion or the whole of the surface of the exterior coating 11 by silk-screen printing. The thickness of the decorative coating 12 can be about 5-8 μm.

The first conductive coating 13 can be a transparent oxide indium tin film formed on the decorative coating 12 and any exposed portion of the exterior coating 11 by silk-screen printing. The thickness of the first conductive coating 13 can be about 2-10 μm, and in this embodiment about 5 μm. The first conductive coating 13 is defined with electric contacts 131 thereon.

The light emitting coating 14 can be an ink coating formed on the exposed surface of the first conductive coating 13 by silk-screen printing. The light emitting coating 14 can contain zinc sulfide, calcium sulfide or strontium sulfide electroluminescent materials. The thickness of the light emitting coating 14 can be about 30-40 μm.

The insulating coating 15 is an ink coating formed on the exposed surface of the light emitting coating 14 by silk-screen printing. The material of the insulating coating 15 can be mainly solidified paste of barium titanate or strontium titanate. The thickness of the insulating coating 15 can be about 20-30 μm. The insulating coating 15 can insulate the first conductive coating 13 from the second conductive coating 16 to prevent short circuits therebetween.

The second conductive coating 16 can be a solidified electric silver paste coating or an electric ink coating. The electric silver paste mainly contains silver powder and binding. The electrical component in the electric ink may be aluminum powder or carbon powder. The thickness of the second conductive coating 16 can be about 8-10 μm. The second conductive coating 16 is defined with electric contacts 161 thereon.

The substrate 17 can be a plastic coating formed on the exposed surface of the second conductive coating 16 by molding.

It should be understood, the decorative coating 12 is not necessary. The first conductive coating 13 can be directly formed on the surface of the exterior coating 11. Also, the first conductive coating 13 can be applied to portions of the surface of the exterior coating 11 by silk-screen printing in a decorative or informative pattern.

It should be understood, the insulating coating 15 is not necessary. The second conductive coating 16 can be directly formed on the light emitting coating 14.

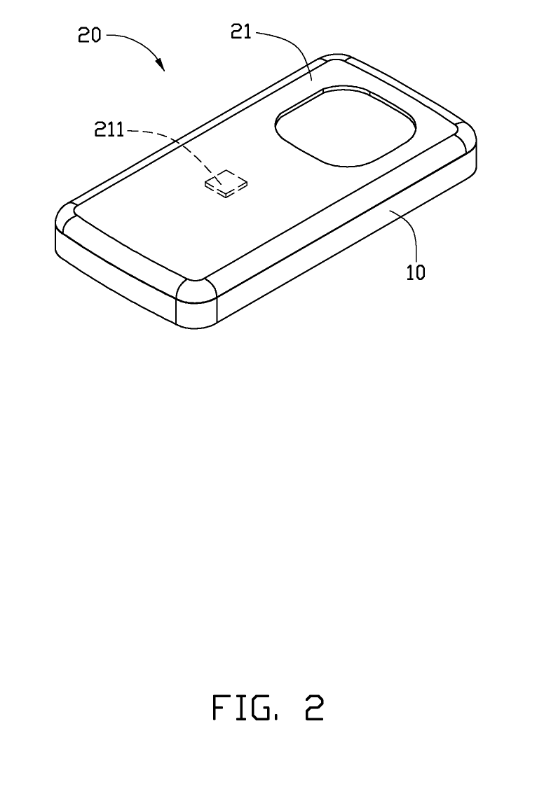

FIG. 1 and FIG. 2 show an electronic device 20 including a main body 21 and a housing 10 fixed to the main body 21. The main body 21 has a power supply controller unit 211. The housing 10 includes an exterior coating 11 and a substrate 17. The housing 10 further includes a decorative coating 12 formed on the exterior coating 11, a first conductive coating 13 formed on the decorative coating 12, a light-emitting coating 14 formed on the first conductive coating 13, an insulating coating 15 formed on the emitting coating 14, and a second conductive coating 16 formed on the insulating coating 15. The coatings 11-16 are applied sequentially to the interior of a mold and are then transferred to the substrate 17 in a molding process to form the housing 10. The first conductive coating 13 is defined with electric contacts 131 thereon and the second conductive coating 16 is defined with electric contacts 161 thereon. These electric contacts can electrically connect with the power supply controller unit 211 in the main body 21 to produce an alternating electric field between the first conductive coating 13 and the second conductive coating 16. The alternating electric field then induces the electroluminescent materials contained in the light emitting coating 14 to emit light that can be observed through the exterior coating 11. As such, a luminescent housing 10 and a luminescent electronic device 20 are obtained. The light emitting coating 14 use less power to emit light than other methods previously described.

The exemplary electronic device 20 may be a mobile phone, a PDA, a camera, a MP3 or a MP4.

It should be understood, however, that even though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A housing, comprising:
an exterior coating;
a first conductive coating;
a light emitting coating;
a second conductive coating; and
a substrate;
wherein the first conductive coating, the light emitting coating and the second conductive coating formed between the exterior coating and the substrate; the substrate formed on the second conductive coating by molding; the first and the second conductive coatings including electric contacts.

2. The housing as claimed in claim 1, wherein the first conductive coating is an oxide indium tin film having a thickness of about 2-10 μm.

3. The housing as claimed in claim 1, wherein the light emitting coating is an ink coating having a thickness of about 30-40 μm.

4. The housing as claimed in claim 1, wherein the second conductive coating is a solidified electric silver paste coating or an electric ink coating having a thickness of about 8-10 μm.

5. The housing as claimed in claim 1, wherein the housing further comprises an insulating coating formed between the light emitting coating and the second conductive coating having a thickness of about 20-30 μm.

6. The housing as claimed in claim 1, wherein the housing further comprises a decorative coating formed between the exterior coating and the first conductive coating having a thickness of about 5-8 μm.

7. The housing as claimed in claim 6, wherein the decorative coating is a transparent or translucent colorful ink coating.

8. The housing as claimed in claim 1, wherein the exterior coating is a transparent plastic coating having a thickness of about 0.1-0.2 μm.

9. An electronic device, comprising:
a main body, the main body having a power supply controller unit; and
a housing, the housing comprising an exterior coating and a substrate;
wherein the housing further comprises a first conductive coating, a light emitting coating and a second conductive coating formed between the exterior coating and the substrate; the substrate formed on the second conductive coating by molding; the first and the second conductive coatings including electric contacts; the electric contacts electrically connecting with the power supply controller unit to create an alternating electric field causing the light emitting coating to emit light.

10. The electronic device as claimed in claim 9, wherein the first conductive coating is an oxide indium tin film having a thickness of about 2-10 μm.

11. The electronic device as claimed in claim 9, wherein the light emitting coating is an ink coating having a thickness of about 30-40 μm.

12. The electronic device as claimed in claim 9, wherein the second conductive coating is a solidified electric silver paste coating or an electric ink coating having a thickness of about 8-10 μm.

13. The electronic device as claimed in claim 9, wherein the housing further comprises an insulating coating formed between the light emitting coating and the second conductive coating having a thickness of about 20-30 μm.

14. The electronic device as claimed in claim 9, wherein the housing further comprises a decorative coating formed between the exterior coating and the first conductive coating having a thickness of about 5-8 μm.

15. The electronic device as claimed in claim 9, wherein the decorative coating is a transparent or translucent colorful ink coating.

16. The electronic device as claimed in claim 9, wherein the exterior coating is a transparent plastic coating having a thickness of about 0.1-0.2 μm
